(19) United States
(12) Patent Application Publication
(10) Pub. No.: US 2005/0046208 A1
(43) Pub. Date: Mar. 3, 2005

(54) Device and method for handling and manipulating an optical data storage disc

(76) Inventor: Andrew R. Tatta, Wayne, PA (US)

Correspondence Address: Eric A. LaMorte;La Morte & Associates, P.C., P. O. Box 434, Yardley, PA, 19067-8434, US

(21) Appl. No.: 10/646,121

(22) Filed: Aug. 25, 2003

(51) Int. Cl. B25B 9/00

(52) U.S. Cl. 294/1.1; 294/25

(57) ABSTRACT

A device and method for manipulating an optical data storage disc, such as a compact disc or a digital videodisc. The device has at least one flat semi-flexible padded surface. The flat padded surface is inserted under the optical data storage disc, while it is in a storage casing, sleeve or tray. The optical data storage disc is then gripped using the device, wherein the flat padded surface is biased against any functional surface of the optical storage disk and the optical storage disc is protected from physical damage or contamination.

### BACKGROUND OF THE INVENTION

1. Field of the Invention

In general, the present invention relates to devices and methods for manually engaging and holding optical data storage discs. More particularly, the present invention primarily relates to devices and methods that are used to remove compact discs from the jewel cases in which they are traditionally sold. The present invention also relates to devices and methods used to insert and extract optical storage discs from media players and recorders.

2. Description of the Prior Art

Optical data storage discs are being used more than ever to store electronic data. Optical data storage discs are also becoming the medium of choice in the commercial sale of electronic data and software. For instance, in the music industry, music is commonly sold to the public on optical data storage discs. In the music industry, such optical data storage discs are commonly referred to as compact discs. In the movie industry, movies are also commonly sold on optical data storage discs. In the movie industry, such movie recordings are typically referred to as digital videodiscs, or DVDs. In the software industry, programs are commonly sold to the public on optical data storage discs. Different manufacturers call such discs different things. However, most commonly the medium of the software is referred to as a compact disc, or CD, since the computer drive used to read such a medium is commonly called a CD drive.

In the music industry, movie industry, console gaming industry and software industry, the optical data storage discs are commonly packaged and sold in plastic cases. The plastic cases are commonly referred to as jewel cases in the industry. Jewel cases are relatively flat square boxes that are notoriously hard to open. Within the case is a hub that receives an aperture in the center of the optical storage disc, thereby retaining the optical storage disc in a set position within the center of the jewel case.

To remove an optical data storage disc from a jewel case, the jewel case must first be opened. A person must then hook a finger under the peripheral edge of the optical data storage disc and pry the disc up to detach the aperture of the disc from the hub in the center of the jewel case. With certain jewel cases, the hub in the center of the jewel box must first be depressed before the optical storage disc can be lifted from its edge. Many jewel boxes also have depressions along the periphery of the optical storage disc that enables a person's finger to between reach under the edge of the optical storage disc so that it can be pried up and out of the jewel box.

Although many optical storage discs store data on both sides of the disc, traditional optical data storage discs store data only on one side of the disc. This functional side of the optical data storage disc is typically placed face down in the jewel case. Accordingly, as a person hooks his/her finger under the edge of the optical data storage disc in order to remove the disc from the jewel case, that person's fingers touch the functional side of the optical data storage disc. Whenever the functional side of the optical data storage disc is touched, there is a chance that this surface can become scratched or dirtied with skin oil or other contaminants. This can eventually corrupt the ability of data to be properly read from the optical data storage disc, thereby destroying the utility of the optical data storage disc.

The same problem occurs when optical data storage discs are removed from paper sleeves, or are placed in a computer drive, CD player or DVD drive. Inevitably, in order for a person to properly grip the optical storage disc, that person's fingers overlap and contact the functional surface of the optical data storage disc that actually stored the digital data.

In the prior art, there have been many devices developed that are intended to help a person engage and manipulate an optical data storage disc without having that person contact the functional surface of that disc. Some prior art devices accomplish this by providing expanders that are inserted into the aperture in the center of the optical data storage disc, wherein the expanders engage the disc along the edge of the central aperture. Such prior art devices are exemplified by U.S. Pat. No. 5,421,630 to Sergi, entitled Compact Disc Handling Device.

One disadvantage of such central aperture expanding devices, is that the hubs in many jewel cases vary greatly in design. Often the hub provides no room for an expander to enter the aperture around the hub. Thus, expanders cannot be used to remove the optical data storage disc from the jewel case.

Other prior art devices extend over the top of an optical data storage disc and contract around the outer peripheral edge of the disc. In this manner, the optical data storage disc can be lifted up at its outer edge. Such prior art devices are exemplified by U.S. Pat. No. 4,997,224 to Pierce, entitled Compact Disc Removal Tool.

A problem with such periphery engaging devices is that when an optical data storage disc is held in a jewel case, CD player or the like, the disc itself is often set in a circular relief. As such, the plastic forming the relief surround the peripheral edge of the optical data storage disc. This obstructs the ability of devices, that shown in the Pierce patent, from being able to be positioned around the optical data storage disc and used.

Recognizing that many jewel cases, CD players, paper sleeves, DVD payers and the like leave no room for either a center aperture expanding device to be used or a peripheral edge contracting device to be used, devices have been developed that contact the surface of the optical data storage disc between the center aperture and the peripheral edge and lift the optical data storage disc using suction. Such prior art devices are exemplified by U.S. Pat. No. 5,201,913 to Vliet, entitled Compact Disc Removal Device.

A disadvantage of suction based devices is that any suction based device would be large and cumbersome. Thus, it is unlikely that such a device would be carried and would be available when you need it.

A need therefore exists for an improved device and method for removing an optical data storage disc that is small, light weight, can be used on any jewel case, or disc player and can be packed within the confines of a jewel case so it is always available when it is needed. This need is met by the present invention as described and claimed below.

### SUMMARY OF THE INVENTION

The present invention is a device and method for manipulating an optical data storage disc, such as a compact disc or a digital videodisc. The device has at least one flat semi-flexible padded surface. The flat padded surface element is inserted under the optical data storage disc, while the optical data storage disc is in a storage casing, protective sleeve or operational tray. The optical data storage disc is then manually gripped using the device. By gripping and lifting the optical data storage disc, using the present invention device, the optical storage disc can be moved without having the functional surfaces of the optical data storage disc being touched by the user's hands. This prevents the user's hands from scratching or otherwise contaminating the optical data storage disc.

The surface of the present invention device that contacts any functional side of the optical data storage disc is preferably padded with a lint-free padding material. In this manner, the device itself does not damage or contaminate the optical data storage disc when it is used to grip the optical data storage disc.

### BRIEF DESCRIPTION OF THE DRAWINGS

For a better understanding of the present invention, reference is made to the following description of exemplary embodiments thereof, considered in conjunction with the accompanying drawings, in which:

FIG. 1 is a perspective view of an exemplary embodiment of the present invention disc manipulation device shown in conjunction with a traditional compact disc and jewel case;

FIG. 2A is a perspective view of the disc manipulation device of FIG. 1 shown in an a diverging configuration;

FIG. 2B is a perspective view of the disc manipulation device of FIG. 1 shown in a closed configuration;

FIG. 3 is a perspective view of the disc manipulation device being inserted into a compact disc jewel case;

FIG. 4 is a perspective view of the disc manipulation device being used to lift a compact disc from a jewel case;

FIG. 5 is a perspective view of a first alternate embodiment of the disc manipulation device; and

FIG. 6 is a perspective view of a second alternate embodiment of the disc manipulation device.

### DETAILED DESCRIPTION OF THE DRAWINGS

Although the present invention disc manipulation device can be used to grasp and manipulate any optical data storage disc that is being held in most any type of storage case, computer tray or player tray, the present invention is particularly well suited for grasping and removing compact discs from plastic jewel cases. Accordingly, the present invention disc manipulation device will be described in an application where it is being used to remove a traditional compact disc from a traditional jewel case in order to set forth the best mode of use contemplated for the invention.

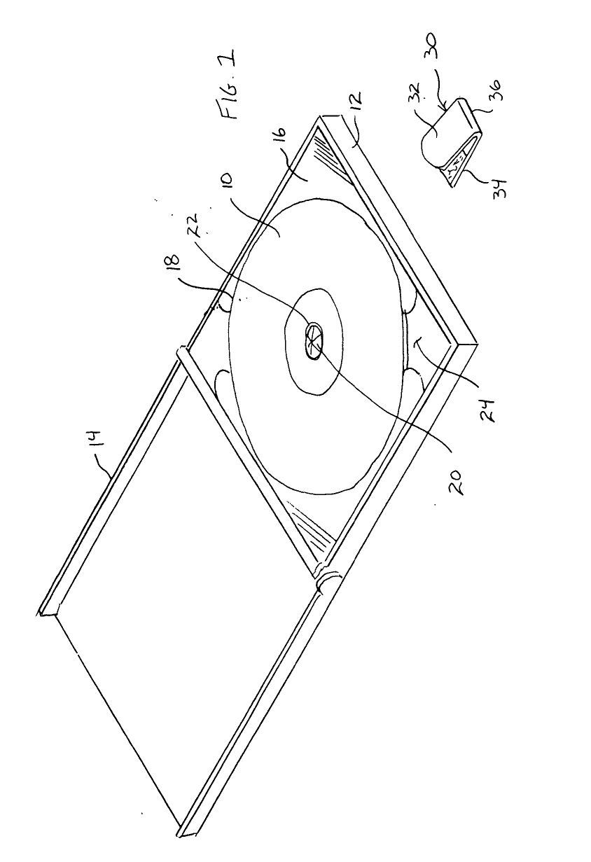

Referring to FIG. 1, a traditional compact disc 10 is shown. The compact disc 10 is of the type that the music industry commonly uses as the medium to record music for sale to the public. The compact disc 10 is being held in a traditional jewel case 12. The jewel case 12 has a lid 14 that opens. Within the jewel case 12 is a plastic insert 16. The plastic insert 16 defines a relief 18 that is sized to receive the compact disc 10. In the center of the plastic insert 16 is a hub 20. The hub 20 extends into the central aperture 22 of the compact disc 10 and mechanically engages the compact disc 10 to prevent it from inadvertently falling out of the relief 18.

To help a person remove the compact disc 10 from the relief 18, depressions 24 are typically formed in the plastic insert 16 near the edges of the relief 18. This enables a person to engage the peripheral edge of the compact disc 10 with their fingers so that the contact disc 10 can be pulled up out of the relief 18 and off of the hub 20.

The present invention disc manipulation device 30 is shown adjacent the jewel case 12. The disc manipulation device 30 has a thin planar top element 32 and a thin planar bottom element 34 that are joined together along a common hinge joint 36. Both the top element 32 and the bottom element 34 are semi-flexible and are easily bent. The top element 32 and the bottom element 34 can either be parts of a common planar structure that was folded in half or two separate planar elements that are joined together, as will later be explained.

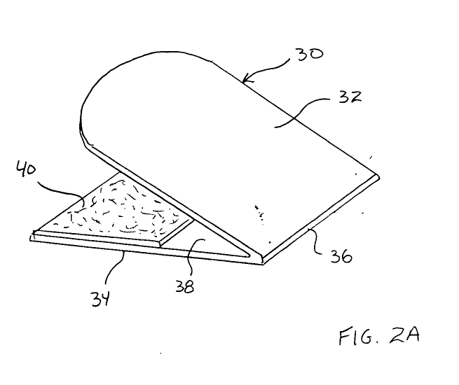

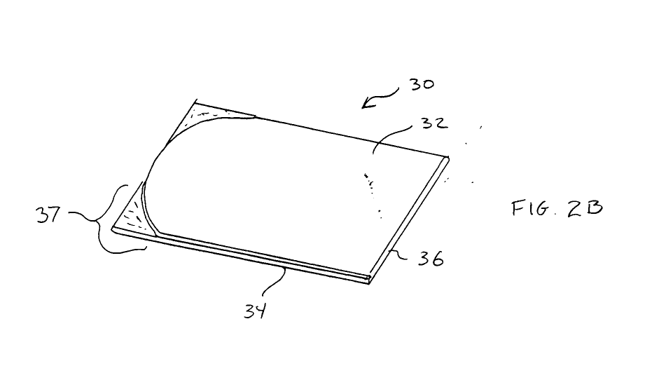

Referring to FIGS. 2A and 2B, it can be seen that the disc manipulation device 30 has a flat planar top element 32 and a flat planar bottom element 34. Both the top element 32 and the bottom element 34 converge at the common hinge joint 36. In the shown embodiment, both the top element 32 and the bottom element 34 are semi-flexible. Accordingly, the top element 32 and the bottom element 34 can be readily bent away from each creating an diverging angle between the top element 32 and the bottom element 34, such as is shown in FIG. 2A. When not bent, the top element 32 and the bottom element 34 are oriented so that the top element 32 lays nearly flat upon the bottom element 34, such as is shown in FIG. 2B.

Although the top element 32 and the bottom element 34 can be the same size, it is preferred that they are not. Rather, in a preferred embodiment, the bottom element 34 is larger than the top element 32. In this manner, by engaging an over-extending area of the bottom element 34, the bottom element 34 can be easily engaged without engaging the top element 32. In the shown embodiment of FIG. 2B, the bottom element 34 has a rectangular shape, while the top element 32 has a rounded shape. Accordingly, when the top element 32 is lying against the bottom element 34, the overextending corner areas 37 of the bottom element 37 extend beyond the periphery of the top element 32. The shapes of the top element 32 and the bottom element 34 shown are merely exemplary and it should be understood that the top element 32 and the bottom element 34 can have any shapes. It is merely preferred that the bottom element 34 over extends the top element 32 in at least one area. By engaging this extending area, the bottom element 34 can be easily separated from the top element 32, thereby changing the disc manipulation device from the flat configuration of FIG. 2B to the spread configuration of FIG. 2A.

Referring back solely to FIG. 2A, it can be seen that the bottom element 34 and the top element 32 have opposing interior faces surfaces. Padding material 40 is provided on these interior face surfaces. The padding material 40 can be a soft blend of paper, a segment of cloth, felt, or a piece of elastomeric material. The padding material 40 can, in fact, be any material, provided it meets two criteria. First, the material selected will not scratch the functional surface of an optical data storage disc. Second, that the padding material 40 will not contaminate the functional surface of an optical data storage disc with oil, lint, particles or any other contaminant.

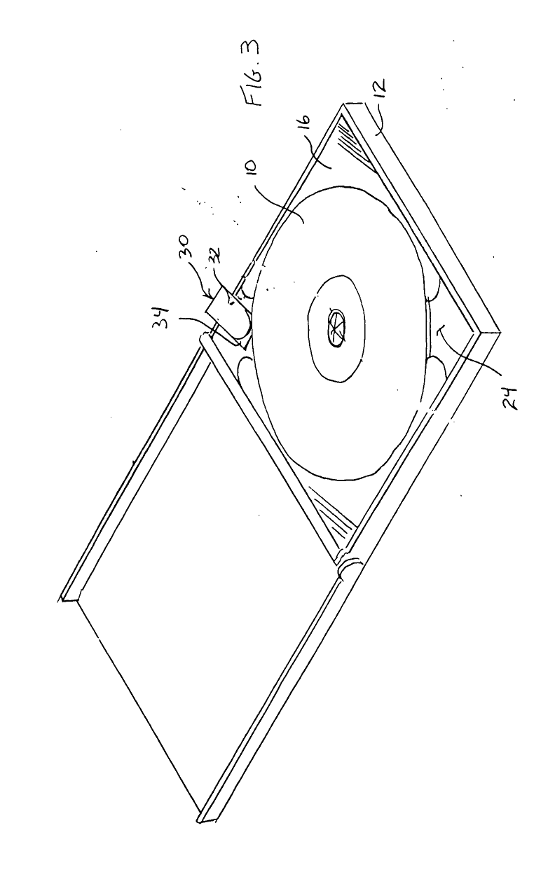

Referring now to FIG. 3, it can be seen that to use the present invention disc manipulation device 30, the bottom element 34 of the disc manipulation device 30 is inserted under a compact disc 10, while the compact disc 10 is being held in the jewel case 12. Since at least one section of the bottom element 34 overextends the top element 32, it is easy to insert only the overextending section of the bottom element 34 under the compact disc 10. Once the overextending section is inserted under the compact disc 10, the disc manipulation device 30 in bent so that the top element 32 will pass over the top of the compact disc 10, while the bottom element 34 advances further under the compact disc 10.

Once the disc manipulation device 30 is positioned so that the bottom element 34 is under the compact disc 10 and the top element 32 is over the compact disc 10, a user squeezes the top element 32 and the bottom element 34 together so that the compact disc 10 is held between the top element 32 and the bottom element 34. The disc manipulation device 30 itself is then used to pry and lift the compact disc 10 out of the jewel casing 12.

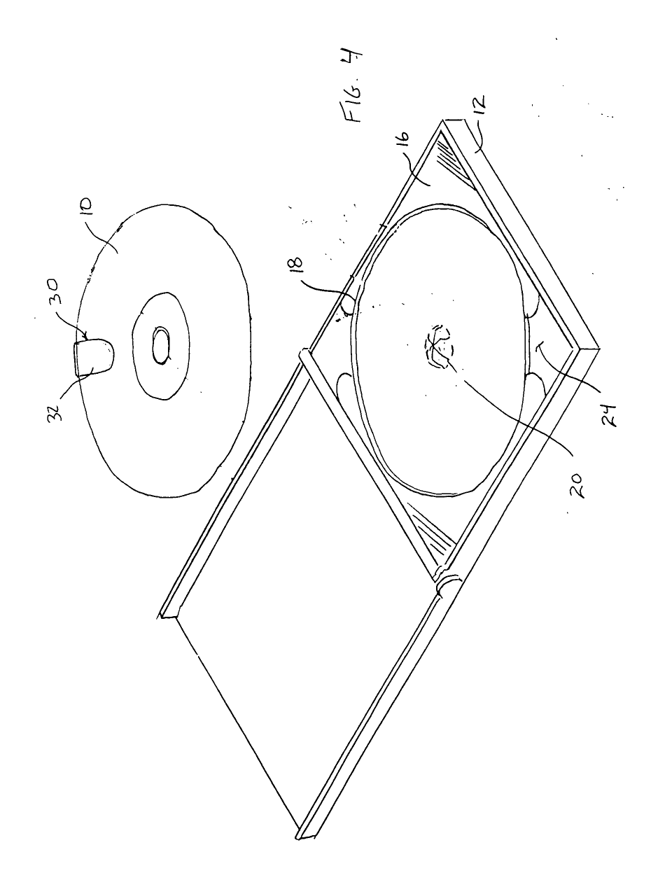

Referring to FIG. 4, it can be seen that as the compact disc 10 is lifted out of the jewel case 12, the compact disc 10 is pried off of the hub 20 of the plastic insert 16. As this is done, the users fingers never touch any functional surface of the compact disc 10. Rather, the only surface that touches the compact disc 10 is the padding material 40 (FIG. 2A) on the interior of the bottom element 34 (FIG. 2A) and top element 32 of the disc manipulation device 30. Accordingly, the chances of a person's fingers directly touching and contaminating the functional surface of the compact disc are greatly reduced.

The only surface that touches the operational surface of the compact disc 10 is the interior of the bottom element 34 (FIG. 2A) of the disc manipulation device 30, wherein that interior surface contains padding material 40 (FIG. 2A). Thus, it is only the padding material 40 that physically contacts any functional surface of the contact disc 10. Since the padding material 40 (FIG. 2A) by its construction does not scratch or contaminant any functional surface of the compact disc 10, the compact disc 10 is in no manner harmed or otherwise degraded by its movement using the disc manipulation device 30.

Although, the removal of a compact disc 10 from a jewel case 12 is illustrated, it will be understood that the disc manipulation device 10 can be used to remove a compact disc from a compact disc player, computer drive, paper sleeve or any other such structure that retains compact discs. The disc manipulation device can then be used to return the compact disc by reversing the method procedure described.

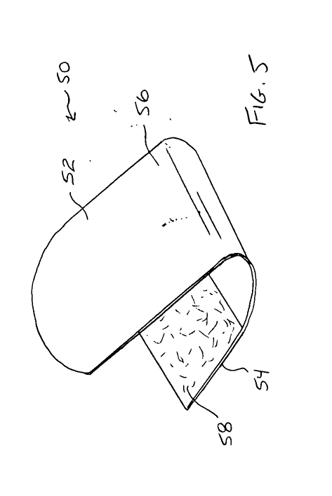

Referring to FIG. 5, an alternate embodiment of the present invention disc manipulation device 50 is shown. In this embodiment, the top element 52 and the bottom element 54 are formed from a single blank of material 56 that is folded over in the center. Precut blanks can be manufactured in bound pads and sold to consumers unfolded. A consumer would pull a blank from the pad and fold it in half to produce the present invention disc manipulation device 50 when needed.

The blanks can be made from a semi-flexible paper material or plastic sheet material. It is preferred that the entire surface that will contact the functional surface of the compact disc be covered with a padding material 58.

From FIG. 5, it can also be seen that anything can be printed upon the exterior of the disc manipulation device. The printing can be instructions of how to use the device or paid advertising, such as is used on match books.

As with all of the embodiments of the present invention disc manipulation device, the disc manipulation device 50 of FIG. 5 is designed to be a disposable item that is to be discarded each time it is used, or after a short period of use. This is to prevent contaminants from collecting on the padding material 58. Once the padding material 58 becomes dirty of otherwise contaminated, the padding material 58 can transfer such contaminants to a compact disc. The padding material 58 is therefore preferably made from white material. In this way, the collection of contaminants of the padding material 58 can be easily observed.

In the embodiment of FIG. 5, a rectangular shaped disc manipulation device 50 is shown that is folded in half when used to grip a compact disc or other optical data storage disc. As such, the disc manipulation device 50 contacts both flat surfaces of the optical data storage disc. It therefore does not matter which side of the disc manipulation device touched a functional surface of the optical data storage disc.

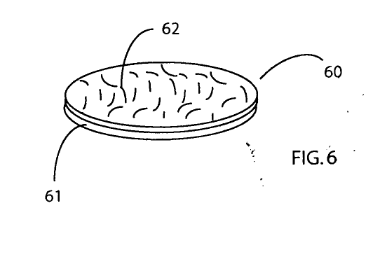

However, many optical data storage discs only store data on one side of the disc. As a result, care only needs to be taken when touching this one functional side of the optical data storage disc. Referring to FIG. 6, another embodiment of the present invention disc manipulation device 60 is shown. In this embodiment, a small piece of semi-flexible paper or plastic 61 is provided that has padding material 62 covering one side. In the shown embodiment of FIG. 6, the disc manipulation device 60 is circular, however any other shape can be used.

To use the disc manipulation device 60, it can be folded in half and used like the embodiment of FIG. 5. However, it can also be used without being folded. In disc manipulation device 60 can be inserted under an optical data storage disc so that the padding material 62 contacts the optical data storage disc. The optical data storage disc can then be grasped between the disc manipulation device 60 and a person's thumb. The person's thumb contacts the non-functional surface of the optical data storage device, while the disc manipulation device 60 contacts and protects the functional surface of the optical data storage device.

The embodiments of the disc manipulation device shown and described can be manufactured for just pennies per unit. As such, it will be understood that at least one disc manipulation device can be provided within the case of every compact disc or other optical data storage disc that is sold. In this way, consumers will have a disc manipulation device available in every jewel case, exactly where and when it is needed.

It will be understood that the embodiments of the present invention disc manipulation device that are described and illustrated herein are merely exemplary and a person skilled in the art can make many variations to the embodiment shown without departing from the scope of the present invention. For example, the disc manipulation device can be made is a variety of lengths, widths and shapes. Images or information can be printed on the disc manipulation device. The printed information can be instructions on how to use the device or sponsored advertising. All such variations, modifications and alternate embodiments are intended to be included within the scope of the present invention as defined by the appended claims.

1. A device for manipulating an optical data storage disc, comprising:
a semi-flexible planar top element having a first face surface;
a semi-flexible planar bottom element having a second face surface, wherein said top element and said bottom element are joined together along a common joint so that said first face surface and said second face surface are in opposition; and
padding material disposed on said first face surface and said second face surface.

2. The device according to claim 1, wherein said bottom element has a larger area than does said top element.

3. The device according to claim 1, wherein said top element and said bottom element are sections of a common blank of material that is folded over to form said common joint.

4. The device according to claim 3, wherein said blank of material is paper.

5. The device according to claim 1, wherein said top element and said bottom element are thin sheets of plastic.

6. The device according to claim 1, wherein said padding material is a fiber felt.

7. A method of manipulating an optical data storage disc having at least one data storage surface, said method comprising the steps of:
providing a device having at least one flat padded surface;
positioning said flat padded surface adjacent said at least one data storage surface of said optical data storage disc; and
manually gripping and moving said optical storage disc, wherein said flat padded surface is biased against said at least one data storage surface and said device prevents direct contact of said at least one data storage surface.

8. The method according to claim 7, wherein further including the step of folding said flat padded surface around an edge of said optical data storage disc.

9. The method according to claim 7, wherein said device has two opposing flat padded surfaces.

10. The method according to claim 9, wherein said two opposing flat padded surfaces are joined together along a common joint.

11. The method according to claim 9, wherein one of said two opposing flat padded surfaces is larger than the other and overhangs the other.

12. A method of removing a compact disc from a jewel case, comprising:
providing a manipulation device having at least one flat padded surface;
advancing said flat padded surface under the compact disc in the jewel case;
gripping the disc utilizing, at least in part, said flat padded surface, wherein said flat padded surface prevents the compact disc from being directly contacted by a user's fingers;
separating said compact disc from the jewel case by manipulating the compact disc when gripped.

13. The method according to claim 12, wherein said compact disc has opposite face surfaces and said method includes gripping said opposite face surfaces between sections of said flat padded surface.

14. The method according to claim 13, wherein said sections of said flat padded surface are formed from a common blank of material and wherein said step of providing a manipulation device includes folding said common blank of material so that said sections of said flat padded surface oppose one another.

15. The method according to claim 12, wherein said sections of said flat padded surface include a bottom section and a top section.

16. The method according to claim 15, wherein said bottom section overextends said top section.
